(19) United States
(12) Patent Application Publication
(10) Pub. No.: US 2007/0010929 A1
(43) Pub. Date: Jan. 11, 2007

(54) Traction control device for preventing engine stalling

(76) Inventors: Masayoshi Takeda, Kariya-city (JP); Kazunori Kadowaki, Kariya-city (JP); Shigeru Saito, Kariya-city (JP)

Correspondence Address: POSZ LAW GROUP, PLC, 12040 SOUTH LAKES DRIVE, SUITE 101, RESTON, VA, 20191, US

(21) Appl. No.: 11/448,871

(22) Filed: Jun. 8, 2006

(30) Foreign Application Priority Data
Jun. 16, 2005 (JP) 2005-176371

(51) Int. Cl. B60T 7/12

(52) U.S. Cl. 701/82; 701/90

(57) ABSTRACT

In order to ensure that traction control is not initiated when an engine stalling tendency exists, no engine stalling tendency is set as a condition for initiating traction control. Furthermore, in order to ensure that an accurate determination of the engine stalling tendency can be made after the initiation of traction control, an engine speed threshold value used to determine whether the engine stalling tendency exists is changed in accordance with a vehicle status. Thus, the engine stalling tendency can be more accurately determined in comparison to when the engine speed threshold value is set as a constant value (a predetermined speed). Accordingly, it is possible to prevent frequent prohibition of traction control even when the possibility of engine stalling is low.

### CROSS REFERENCE TO RELATED APPLICATION

This application is based upon and claims the benefit of Japanese Patent Application No. 2005-176371 filed on Jun. 16, 2005, the content of which are incorporated herein by reference.

### FIELD OF THE INVENTION

The present invention relates to a traction control device capable of preventing an engine from stalling (hereinafter referred to as “engine stalling”) as a result of acceleration slip.

### BACKGROUND OF THE INVENTION

To perform traction control in a vehicle with a manual transmission, there is a risk of engine stalling due to a reduction in engine speed that results from the suppression of acceleration slip. The risk of engine stalling becomes particularly high in the case of an extremely low μ road whose road surface friction coefficient μ is extremely low on which acceleration slip has occurred at a high shift position. The same also holds when acceleration slip has occurred at the start of slope travel of a vehicle loaded down with cargo or many occupants.

A traction control device capable of preventing engine stalling resulting from such acceleration slip is proposed in published patent application, Japanese translation of PCT international application No. HEI-2-501293.

In the traction control device described in the above application, an engine stalling tendency is detected based on the engine speed during traction control. The engine stalling tendency is determined if the engine speed is equal to or less than a predetermined speed. In such case, a control pressure for brake control is set lower than normal, or the engine output is set higher than normal in order to prevent engine stalling.

However, engine stalling does not always occur even if a certain set of conditions are met. Therefore, accurately determining whether the engine stalling tendency exists is difficult. Once traction control is initiated, it is difficult to accurately prevent engine stalling. Consequently, ensuring that the traction control itself is not initiated when the engine stalling tendency exists is preferable.

Meanwhile, due to the fact that engine stalling does not always occur even if a certain set of conditions are met, even if traction control has been initiated, it is impossible to accurately prevent engine stalling by only executing control that simply terminates traction control when the engine speed is equal to or less than a predetermined speed.

For instance, there is a possibility that engine stalling may also occur when the engine speed is higher than the predetermined speed. Taking this into account and setting a threshold value (i.e., the predetermined speed) used as the condition for terminating traction control higher may be able to prevent engine stalling. However, this means that traction control would be frequently terminated even when the possibility of engine stalling was low, which ultimately makes it impossible to accurately suppress acceleration slip.

### SUMMARY OF THE INVENTION

In light of the foregoing points, it is an object of the present invention to prevent an inability to accurately determine engine stalling that is due to the initiation of traction control when there is the engine stalling tendency.

Furthermore, it is a second object of the present invention to enable an accurate detection of the engine stalling when traction control has been initiated.

In order to achieve the above objects, according to a first aspect of the present invention, if an engine stalling tendency detection unit detects an engine stalling tendency, then initiation of traction control is prohibited regardless of whether a traction control initiation determination unit determines that a slip ratio is equal to or greater than a predetermined slip ratio.

In order to ensure that traction control is not initiated when an engine stalling tendency exists, a condition for initiating traction control is thus set. Therefore, it is possible to prevent engine stalling due to an inability to accurately detect the engine stalling tendency during the execution of traction control.

In this case, according to a second aspect of the present invention, a threshold value setting unit for setting the predetermined threshold value used by the engine stalling tendency detection unit is provided. Also, the threshold value setting unit can set the predetermined threshold value in accordance with a vehicle status.

In this manner, the engine speed threshold value used to determine whether the engine stalling tendency exists is changed in accordance with a vehicle status. Thus, the engine stalling tendency can be more accurately determined in comparison to when the engine speed threshold value is set as a constant value (a predetermined speed). Accordingly, it is possible to prevent frequent prohibition of traction control even when the possibility of engine stalling is low.

According to a third aspect of the present invention, if a traction control initiation determination unit detects that the slip ratio is equal to or greater than the predetermined slip ratio and traction control is initiated, then the traction control is subsequently terminated if the engine stalling tendency detection unit determines that the engine speed is equal to or less than the predetermined threshold value.

Therefore, in order to make detection of the engine stalling tendency as accurate as possible after traction control has been initiated, the engine speed threshold value used for determining whether the engine stalling tendency exists is changed in accordance with a vehicle status. Thus, the engine stalling tendency can be more accurately determined compared to when the engine speed threshold value is set as a constant value (a predetermined speed). This in turn can lower the possibility of an inability to prevent engine stalling, as well as the frequent termination of traction control even when the possibility of engine stalling is low.

For instance, according to a fourth aspect of the present invention, the threshold value setting unit may use a parameter representing driving force, and set the predetermined threshold value based on a variation in the driving force represented by a variation in the parameter. The predetermined threshold value can be set larger as the driving force decreases. In this case, for example, according to a fifth aspect of the present invention, a gear position may be used as the parameter representing driving force.

Furthermore, according to a sixth aspect of the present invention, the threshold value setting unit may use a parameter related to running resistance, and set the predetermined threshold value based on a variation in the parameter. The predetermined threshold value can be set larger as the running resistance increases. In this case, for example, according to a seventh aspect of the present invention, a vehicle weight, a road gradient, or both may be used as the parameter related to running resistance.

According to a ninth aspect of the present invention, the traction control device according to the first aspect of the present invention described above may also be applied to a vehicle with a manual transmission.

### BRIEF DESCRIPTION OF THE DRAWINGS

Other objects, features and advantages of the present invention will be understood more fully from the following detailed description made with reference to the accompanying drawings. In the drawings:

FIG. 1 is a drawing showing an overall configuration of a vehicle control system that realizes a traction control device in the first embodiment according to the present invention;

FIG. 2 is a flowchart of a traction control initiation determination in traction control processing;

FIG. 3 is a flowchart of a traction control termination determination in traction control processing;

FIG. 4 is a characteristic graph showing variations in an engine speed threshold value corresponding to a gear position;

FIG. 5 is a characteristic graph showing variations in the engine speed threshold value corresponding to the gear position and a vehicle weight;

FIG. 6 is a characteristic graph showing variations in the engine speed threshold value corresponding to the gear position and a road gradient; and

FIG. 7 is a flowchart of calculation processing for the engine speed threshold value that is executed by an ECU 1 in the traction control device of a fourth embodiment according to the present invention.

### DETAILED DESCRIPTION OF THE PREFERRED EMBODIMENTS

Hereinafter, embodiments of the present invention will be described with reference to the drawings. Note that like or equivalent parts referred to in the following embodiments are denoted by like numbers in the drawings.

### First Embodiment

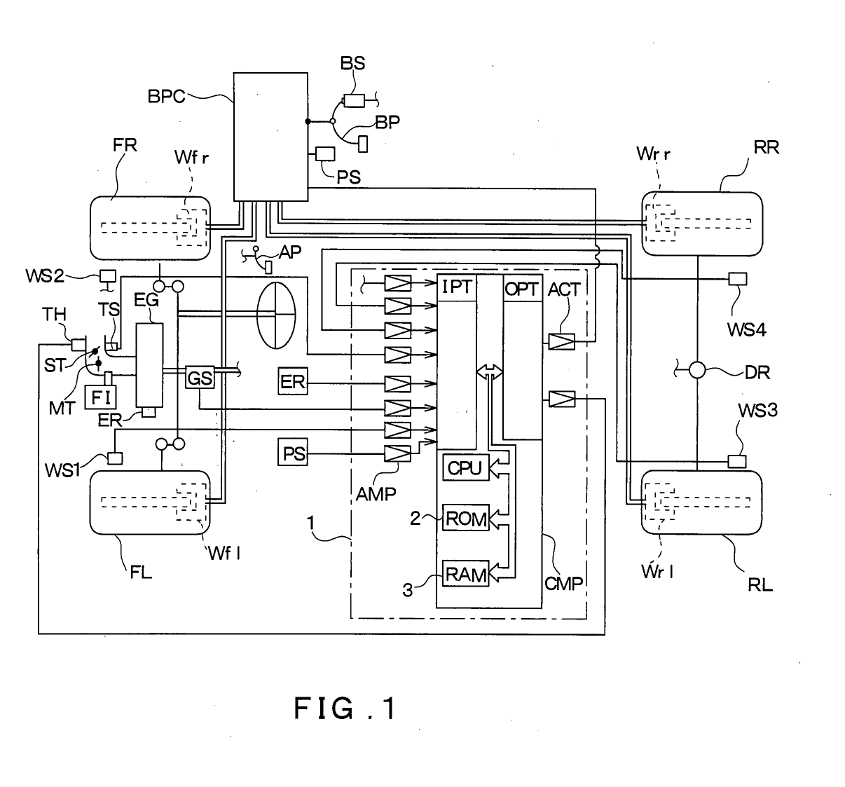

FIG. 1 shows an overall configuration of a vehicle control system that realizes a traction control device according to a first embodiment of the present invention. The traction control device realized by the vehicle control system may be applied to both a vehicle with a manual transmission and one with an automatic transmission. However, the traction control device is especially applicable to vehicles with manual transmissions, which are more prone to engine stalling. The configuration of the vehicle control system will be explained below with reference to FIG. 1.

As shown in FIG. 1, the vehicle control system is structured to include an engine EG, a gear shifter (transmission) GS, a brake pressure control device BPC. Further included are a group of various sensors, an electronic control device (hereinafter referred as an “ECU”) 1, and vehicle wheels FL, FR, RL, RR, which are respectively provided with wheel cylinders Wfl, Wfr, Wrl, Wrr.

Note that the vehicle wheels FL, FR, RL, RR indicate vehicle wheels on the front left side, front right side, rear left side and rear right side, respectively. Also note that a mark “**” used in the following description corresponds to a suffix indicating the vehicle wheels FL to RR.

The engine EG is an internal combustion engine provided with a throttle control device TH and a fuel injection device FI. The engine EG is driven based on an operation amount of an accelerator pedal AP corresponding to a driver's drive request, and an engine control signal from the ECU 1. More specifically, the throttle control device TH controls a main throttle opening of a main throttle valve MT in accordance with operation of the accelerator pedal AP. The throttle control device TH also drives a sub throttle valve ST in accordance with a control signal from the ECU 1, and controls the sub throttle opening. The fuel injection device FI is driven based on a command signal from the ECU 1, and controls a fuel injection amount. Driving of the throttle control device TH and the fuel injection device FI accordingly controls an engine speed of the engine EG.

It should be noted that a vehicle used in the embodiment is a front-engine/rear-drive (FR) vehicle, and has a structure in which the engine EG is connected to the vehicle wheels RL, RR at the vehicle rear, via the gear shifter GS and a rear differential DR. Accordingly, the vehicle wheels FL, FR are driven wheels, and the vehicle wheels RL, RR are driving wheels.

The gear shifter GS switches a gear position of a transmission. A gear position in the gear shifter GS is transmitted to the ECU 1 from a gear position sensor provided within the gear shifter GS. The gear position of the gear shifter GS is regulated based on a gear position control signal (not shown) from the ECU 1.

The brake pressure control device BPC regulates a brake pressure (a wheel cylinder pressure) applied to the wheel cylinders Wfl, Wfr, Wrl, Wrr respectively provided in the vehicle wheels FL, FR, RL, RR. Such regulation is performed corresponding to an operation amount of a brake pedal BP that is depressed in accordance with a driver's brake request, and a brake request based on traction control executed by the ECU 1. More specifically, the brake pressure control device BPC is provided with a master cylinder (not shown) and a pressure sensor PS that detects an output brake pressure (a master cylinder pressure) of the master cylinder. In addition, the brake pressure control device BPC is structured such that an output signal of the pressure sensor PS is input to the ECU 1. Also, an actuator not shown (such as a solenoid or the like) provided in the brake pressure control device BPC is driven based on a brake control signal from the ECU 1, whereby the wheel cylinder pressure is regulated.

The group of various sensors, in addition to the sensors above, also includes vehicle wheel speed sensors WS1 to WS4, a brake switch sensor BS, a throttle sensor TS, and an engine rotation sensor ER.

The vehicle wheel speed sensors WS1 to WS4 are respectively disposed in the vehicle wheels FL, FR, RL, RR. In addition, the vehicle wheel speed sensors WS1 to WS4 are connected to the ECU 1, and each outputs a pulse signal to the ECU 1 with a pulse number that is proportional to a rotational speed of the respective vehicle wheels, i.e., a vehicle-wheel speed.

The brake switch sensor BS detects that the driver has depressed the brake pedal BP. A detection signal from the brake switch sensor BS is input to the ECU 1.

The throttle sensor TS detects whether the engine EG is operating in an idling region or an output region, and also detects the throttle opening of the main throttle valve MT and the sub throttle valve ST. The throttle sensor TS outputs an idle switch signal that represents whether the engine EG is operating in the idling region or the output region as an ON/OFF signal, and respective throttle opening signals of the throttle valves MT, ST. Such signals are output to the ECU 1. Based on the idle switch signal of the throttle sensor TS, operation or non-operation of the accelerator pedal AP can be detected.

The engine rotation sensor ER detects an engine speed. The engine speed is used as a parameter for an engine torque, and an engine torque curve is determined for each type of engine EG depending on the engine speed.

The ECU 1 has a microcomputer CMP. Included in the microcomputer CMP are an input port IPT, an output port OPT, a processing unit CPU, and a ROM 2 and a RAM 3 that act as storage units. Further included are a control timer and a counter (both not shown). A configuration is achieved in which these respective portions are interconnected via a bus.

Output signals from the vehicle wheel speed sensors WS1 to WS4 and the brake switch sensor BS are input via an amplification circuit AMP to the input port IPT and then to the processing unit CPU. In addition, respective control signals are output to the throttle control device TH and the brake pressure control device BPC from the output port OPT via a drive circuit ACT.

A program for executing traction control is stored in the ROM 2. The processing unit CPU executes processing in accordance with the program stored in the ROM 2 while an ignition switch (not shown) is ON. Variable data required for executing the program is temporarily stored in the RAM 3.

A control system with the above configuration is used to execute processing for traction control. Traction control processing is executed by the ECU 1. Various values calculated in various calculation processing executed by the ECU 1 are used to execute traction control processing. Details regarding the various calculation processing for traction control processing are omitted here, since the processing used is commonly known for engine control and the like. A description of traction control processing follows below. Note that processing to set a specific control amount in the traction control processing, that is, processing to set a control amount for engine control and a control amount for brake control, resembles processing already in general use. Only a traction control initiation determination and a traction control termination determination in the traction control processing, which differ from that in current processing, will be described here.

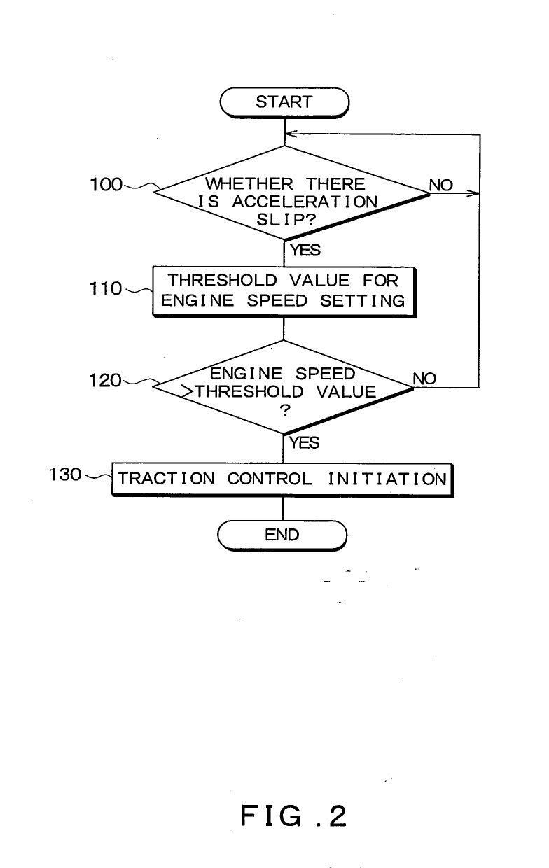

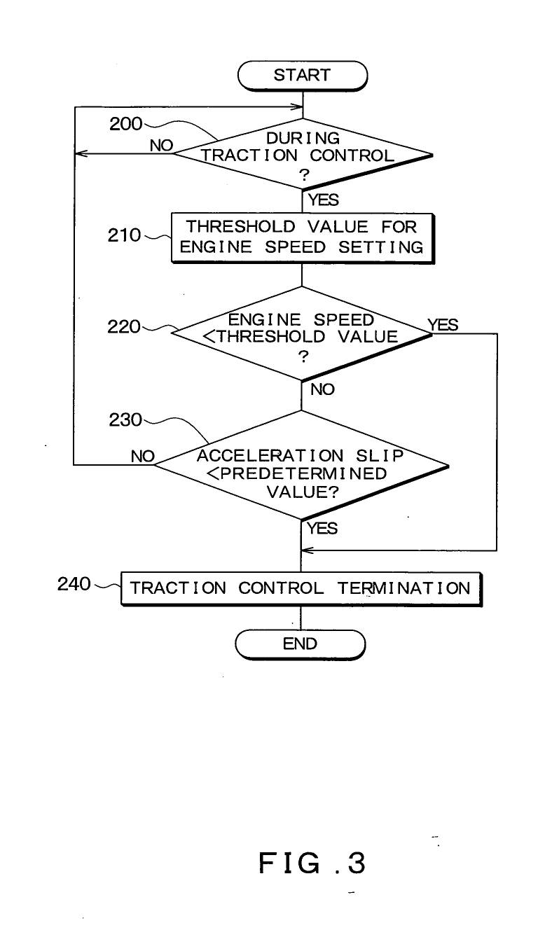

FIG. 2 shows a flowchart of the traction control initiation determination in traction control processing, and FIG. 3 shows a flowchart of the traction control termination determination in traction control processing. The respective routines shown in FIGS. 2 and 3 are executed at predetermined calculation cycles once the ignition switch is turned ON and the microcomputer is started up. Furthermore, the routines are respectively executed for the vehicle wheels RL, RR, i.e., the driving wheels.

In the traction control initiation determination shown in FIG. 2, it is first determined at 100 whether there is acceleration slip. This determination is performed based on whether a slip ratio exceeds a predetermined threshold value. The slip ratio is expressed as the difference between an estimated vehicle body speed VB, which is found from a vehicle wheel speed VW** of the respective vehicle wheels FL, FR, RL, RR in separate calculation processing, and vehicle wheel speeds VWRL, VWRR of the vehicle wheels RL, RR, i.e., the driving wheels (=(VW**−VB)/VB). If the slip ratio exceeds the predetermined threshold value, then the routine proceeds to processing at 110 where it is assumed that traction control may have to be initiated, after which the routine proceeds to processing at 120. If the slip ratio does not exceed the predetermined threshold value, then the process returns to 100 again.

Note that a portion among the ECU 1 which performs such processing corresponds to a traction control initiation determination unit in the present invention.

At 110, a threshold value for the engine speed is set. A portion among the ECU 1 which performs such processing corresponds to a threshold value setting unit in the present invention.

The threshold value used here is set in accordance with a vehicle status. In this embodiment, the threshold value is set in accordance with the gear position, which is a characteristic that indicates a vehicle status. Also note that the gear position is detected based on a detection signal from a gear position sensor (not shown) that is provided in the gear shifter GS.

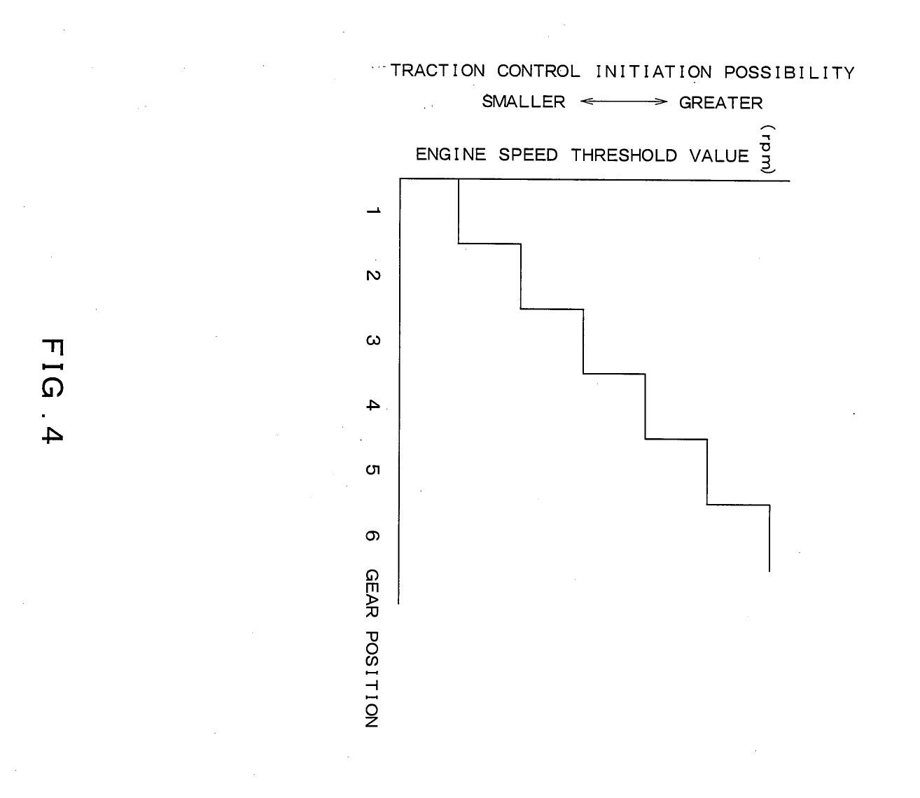

FIG. 4 is a characteristic graph showing variations in an engine speed threshold value corresponding to the gear position. As the graph shows, the higher the gear position, the greater the engine speed threshold value set. The characteristic graph or the relationship between the gear position and the engine speed threshold value are stored in the ROM 2 in a corresponding form. Based on such stored contents in the ROM 2, the engine speed threshold value is set in accordance with the current gear position.

It should be noted that the graph shows an example in which as the gear position increases in a stepped manner, the engine speed threshold value increases by a corresponding and equivalent amount of speed. However, this is merely an example; more specifically, the threshold value is set based on a gear ratio set for each gear position.

Once the engine speed threshold value is set as explained above, the routine proceeds to processing at 120, where it is determined whether the current engine speed exceeds the threshold value set at 110. Note that a portion among the ECU 1 which performs such processing corresponds to an engine stalling tendency detection unit in the present invention.

If the engine speed exceeds the threshold value at this time, then it is assumed that no engine stalling tendency exists and that the conditions for initiating traction control are met. The routine then proceeds to processing at 130 where traction control is initiated and a traction control ON flag, which indicates traction control is being executed, is set. Thus, control amounts for engine control and brake control are calculated using commonly known methods, and the driving force or braking torque is regulated so as to suppress acceleration slip.

Meanwhile, if it is determined at 120 that the engine speed does not exceed the threshold value, then it is assumed that an engine stalling tendency exists and that the conditions for initiating traction control have not been met. The process thus returns to 100 again.

As explained above, the determination of whether the engine stalling tendency exists is performed as a condition for initiating traction control, and traction control is not initiated if the engine stalling tendency exists. By ensuring that the traction control does not initiate in this manner, it is possible to prevent the initiation of traction control regardless of there being the engine stalling, and also possible to prevent an inability to accurately determine the occurrence of engine stalling.

Meanwhile, in the traction control termination determination shown in FIG. 3, it is first determined at 200 whether traction control is being executed. This determination is performed based on whether the traction control ON flag mentioned at 130 in FIG. 2 is set. If the traction control ON flag was set at 130, then it is assumed that traction control is being executed, and the routine proceeds to processing at 210. If the traction control ON flag was not set, then it is assumed that traction control is not being performed, and the routine returns to 200 again.

Next at 210, an engine speed threshold value is set. The threshold value used here is also set using the same method as at 110 in FIG. 2, and is set in accordance with the gear position.

The routine subsequently proceeds to processing at 220, where it is determined whether the current engine speed is less than the threshold value set at 210. If the current engine speed is not less than the threshold value at this time, then it is assumed that no engine stalling tendency exists and that traction control may be continued. The routine then proceeds to processing at 230. Alternatively, if the current engine speed is less than the threshold value, then it is assumed that the engine stalling tendency exists, and that the conditions for terminating traction control are met. The routine then proceeds to processing at 240.

At 230, it is determined whether the acceleration slip is less than a predetermined value. This is equivalent to a generally used condition for terminating traction control. That is, if the acceleration slip (slip ratio) is less than the predetermined value, then it should no longer be necessary to suppress the acceleration slip, thus relieving the necessity for traction control. Therefore, in the case of a positive determination at 230, the routine proceeds to processing at 240. But in the case of a negative determination, it is assumed that the conditions for terminating traction control have not been met, and the process returns to 200 again.

At 240, traction control is terminated and the traction control ON flag is reset. Accordingly, controls for driving force or braking torque based on the traction control are canceled.

Thus, the engine speed threshold value used to determine whether the engine stalling tendency exists is changed in accordance with the vehicle status even after traction control has been initiated. Therefore, it is also possible to accurately detect the engine stalling tendency during the execution of traction control.

In this embodiment, as explained above, traction control is not initiated if the engine stalling tendency exists. Since traction control is designed not to initiate in this manner, it is possible to prevent engine stalling due to an inability to accurately detect the engine stalling tendency during the execution of traction control.

In order to make detection of the engine stalling tendency as accurate as possible, the engine speed threshold value used to determine whether the engine stalling tendency exists is changed in accordance with a vehicle status. Thus, the engine stalling tendency can be more accurately determined in comparison to when the engine speed threshold value is set as a constant value (a predetermined speed). Accordingly, it is possible to prevent frequent prohibition of traction control even when the possibility of engine stalling is low.

Furthermore, in order to make detection of the engine stalling tendency as accurate as possible after traction control has been initiated, the engine speed threshold value used for determining whether the engine stalling tendency exists is changed in accordance with a vehicle status. Thus, the engine stalling tendency can be more accurately determined compared to when the engine speed threshold value is set as a constant value (a predetermined speed). This in turn can lower the possibility of an inability to prevent engine stalling, as well as the frequent termination of traction control even when the possibility of engine stalling is low.

### Second Embodiment

A second embodiment of the present invention will be explained. This embodiment takes into account vehicle weight, in addition to the gear position used in the first embodiment, as a parameter indicating a vehicle status used to set the engine speed threshold value for determining the engine stalling tendency.

As a vehicle status, in other words, any increase or decrease in the vehicle weight will change running resistance. Therefore, if the vehicle weight changes, then the engine speed until the engine stalling tendency occurs changes as well. Taking this into consideration, the engine speed threshold value used to determine the engine stalling tendency is changed based on the vehicle weight in the second embodiment.

Note that with respect to other points, including the methods for the traction control initiation determination and the traction control termination determination, all are similar to the first embodiment and only differences therewith will be explained below.

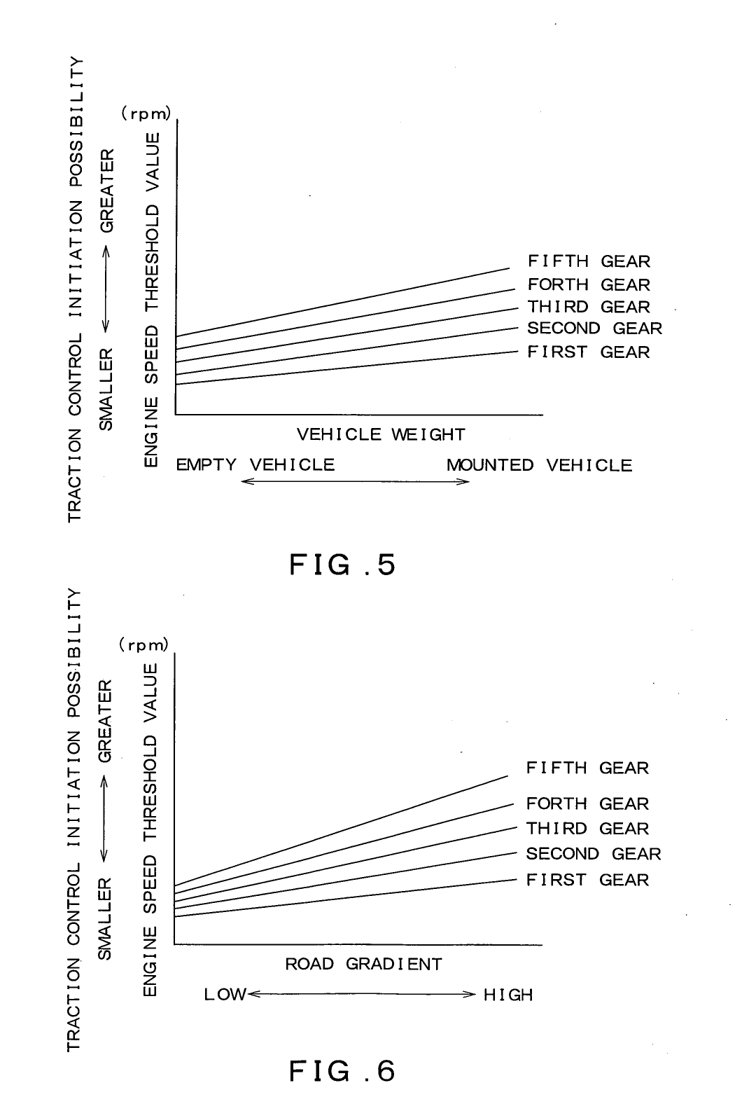

FIG. 5 is a characteristic graph showing variations in the engine speed threshold value corresponding to the gear position and the vehicle weight. As the graph shows, the higher the gear position, the greater the engine speed threshold value set. Moreover, the heavier the vehicle weight, the greater the engine speed threshold value set. The characteristic graph or the relationship between the gear position, the vehicle weight, and the engine speed threshold value are stored in the ROM 2 in a corresponding form. Based on such stored contents in the ROM 2, the engine speed threshold value is set in accordance with the current gear position and the vehicle weight.

In this manner, the engine speed threshold value can be set based on a more accurate vehicle status. Therefore, it is possible to achieve the effect of the first embodiment to a greater degree.

Note that in this embodiment, the engine speed threshold value is changed based on the vehicle weight, which may be found as follows, for example. A weight sensor provided in a vehicle suspension or the like transmits a detection signal to the ECU 1. Based on the detection signal, the ECU 1 can then calculate the vehicle weight.

Moreover, given that the braking force (brake pressure) is calculated in the execution of brake control by the ECU 1, the vehicle weight can be estimated from a relationship between the braking force and a deceleration calculated in advance as a derivative of the vehicle body speed VB. This may be stored in the RAM 3. The vehicle weight can also be estimated in the execution of engine control by the ECU 1 from a relationship between acceleration force (engine output) and an acceleration calculated as a derivative of the vehicle body speed VB. This may also be stored in the RAM 3. If the vehicle is mounted with an acceleration sensor, the acceleration or deceleration can be detected in such cases based on a detection signal from the acceleration sensor.

### Third Embodiment

A third embodiment of the present invention will be explained. This embodiment takes into account a road gradient, in addition to the gear position used in the first embodiment, as a parameter indicating a vehicle status used to set the engine speed threshold value for determining the engine stalling tendency.

As a vehicle status, in other words, any change in the road gradient will also change running resistance, similar to the second embodiment. Therefore, if the road gradient changes, then the engine speed changes as well until the engine stalling tendency occurs. Taking this into consideration, the engine speed threshold value used to determine the engine stalling tendency is changed based on the road gradient in the third embodiment.

Note that with respect to other points, including the methods for the traction control initiation determination and the traction control termination determination, all are similar to the first embodiment and only differences therewith will be explained below.

FIG. 6 is a characteristic graph showing variations in the engine speed threshold value corresponding to the gear position and a road gradient. As the graph shows, the higher the gear position, the greater the engine speed threshold value set. Moreover, the steeper the road gradient, the greater the engine speed threshold value set. The characteristic graph or the relationship between the gear position, the road gradient, and the engine speed threshold value are stored in the ROM 2 in a corresponding form. Based on such stored contents in the ROM 2, the engine speed threshold value is set in accordance with the current gear position and the road gradient.

Note that the road gradient described in FIG. 6 corresponds to a road gradient of an uphill road. The present invention is, however, applicable to a road gradient of a downhill road. In this case, a characteristic graph showing variations in the engine speed threshold value corresponding to the gear position and a road gradient should be an inverse characteristic of that of the uphill road shown in FIG. 6.

In this manner, the engine speed threshold value can be set based on a more accurate vehicle status. Therefore, it is possible to achieve the effect of the first embodiment to a greater degree.

Note that in this embodiment, the engine speed threshold value is changed based on the road gradient, which may be found as follows, for example. A road gradient sensor directly transmits a detection signal corresponding to the road gradient to the ECU 1. Based on the detection signal, the ECU 1 can then calculate the road gradient. Alternatively, the road gradient may be estimated from the difference in a vehicle wheel acceleration dVW** that is calculated as a derivative of the vehicle wheel speed VW**, and the acceleration that is found with a detection signal from the acceleration sensor. If the vehicle has not started moving (is stopped), then the detection signal from the acceleration sensor only represents an acceleration component due to gravity, and can therefore be used to estimate the road gradient as well.

Moreover, given that the braking force (brake pressure) is calculated in the execution of brake control by the. ECU 1, the road gradient can be estimated from a relationship between the braking force and a deceleration calculated in advance as a derivative of the vehicle body speed VB. This may be stored in the RAM 3. The road gradient can also be estimated in the execution of engine control by the ECU 1 from a relationship between acceleration force (engine output) and an acceleration calculated as a derivative of the vehicle body speed VB. This may also be stored in the RAM 3. If the vehicle is mounted with an acceleration sensor, the acceleration or deceleration can be detected in such cases based on a detection signal from the acceleration sensor.

### Fourth Embodiment

A fourth embodiment of the present invention will be explained. This embodiment takes into account the gear position, the vehicle weight, and the road gradient used in the above first to third embodiments in order to set the engine speed threshold value used for determining the engine stalling tendency. It should also be noted that the fourth embodiment will be described in terms of the traction control device provided with an acceleration sensor that was applied to the first embodiment.

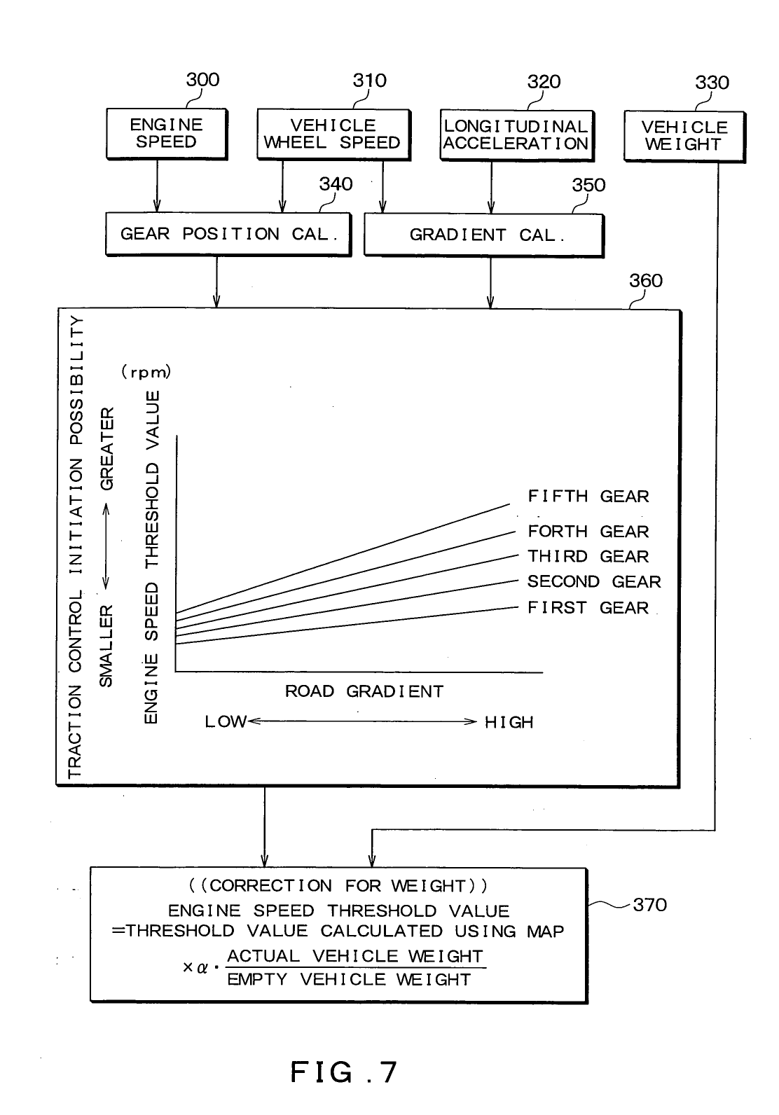

FIG. 7 shows a block diagram of a portion that executes calculation processing for the engine speed threshold value among the ECU 1 in the traction control device of the fourth embodiment.

As the diagram shows, first as indicated at 300 to 330, respective calculations for the engine speed, the vehicle wheel speed, longitudinal acceleration, and the vehicle weight are performed. The engine speed is found based on a detection signal from the engine rotation sensor ER, and the vehicle wheel speed is found based on detection signals from the vehicle wheel speed sensors WS1 to WS4. In addition, the longitudinal acceleration is found based on a detection signal from the acceleration sensor. The vehicle weight is found based on a detection signal from the weight sensor.

As indicated at 340, a gear position calculation is performed next based on the engine speed found at 300 and the vehicle wheel speed found at 310. That is, the vehicle wheel speed estimated from the engine speed is set for each gear position, and therefore the gear position can be found by detecting which gear position the wheel speed at that time corresponds to.

At 350, a road gradient calculation is performed based on the vehicle wheel speed found at 310 and the longitudinal acceleration found at 320. More specifically, a commonly known method is used in which the vehicle wheel acceleration is found from the vehicle wheel speed, and the road gradient is calculated based on the difference in the vehicle wheel acceleration and the acceleration found from a detection signal of the acceleration sensor.

Next at 360, the engine speed threshold value is calculated based on the relationship between the gear position found at 340 and the road gradient found at 350. The relationship between the gear position, the road gradient, and the engine speed threshold value at this time is shown at 360 in FIG. 7, and is similar to that in FIG. 6 described above.

The routine subsequently proceeds to processing at 370 where the engine speed threshold value calculated at 360 is corrected to take into account the vehicle weight found at 330. More specifically, the engine speed threshold value is ultimately found as follows. The engine speed threshold value calculated at 360 assumes a vehicle weight when the vehicle is empty (an empty vehicle weight). Therefore, a ratio of the actual vehicle weight to the empty vehicle weight is calculated, and the ratio is multiplied by a predetermined constant to find a correction coefficient. The engine speed threshold value calculated at 360 is then multiplied by the correction coefficient.

As explained above, the engine speed threshold value used to determine the engine stalling tendency is changed based on the gear position, the vehicle weight, and the road gradient. In this manner, the engine speed threshold value can be set based on a more accurate vehicle status. Therefore, it is possible to achieve the effect of the first embodiment to a greater degree.

### Other Embodiments

In the above embodiments, vehicle statuses used include the gear position, i.e., a parameter representing driving force, and the vehicle weight and the road gradient, i.e., parameters representing running resistance. The engine speed threshold value used to determine the engine stalling tendency is changed based on such vehicle statuses. However, other vehicle statuses may be taken into account, such as a road surface friction coefficient μ, to change the engine speed threshold value used for determining the engine stalling tendency.

Furthermore, the above embodiments were examples that combined both a determination of the engine stalling tendency before the execution of traction control as shown in FIG. 2 and a determination of the engine stalling tendency after the execution of traction control as shown in FIG. 3. However, the respective determinations may also be singly performed.

Note further that the contents shown in each figure correspond to portions for executing various processing.

While the above description is of the preferred embodiments of the present invention, it should be appreciated that the invention may be modified, altered, or varied without deviating from the scope and fair meaning of the following claims.

What is claimed is:

1. A traction control device comprising:
a traction control unit for executing traction control to suppress acceleration slip of a driving wheel;
a traction control initiation determination unit for determining the initiation of traction control when a slip ratio of the driving wheel is equal to or greater than a predetermined slip ratio; and
an engine stalling tendency detection unit for detecting an existence of an engine stalling tendency that a value representing the engine speed is equal to or less than a predetermined threshold value; wherein
if the engine stalling tendency detection unit detects the engine stalling tendency, then initiation of traction control is prohibited regardless of whether the traction control initiation determination unit determines that the slip ratio is equal to or greater than the predetermined slip ratio.

2. The traction control device according to claim 1, further comprising:
a threshold value setting unit for setting the predetermined threshold value used by the engine stalling tendency detection unit, wherein
the threshold value setting unit sets the predetermined threshold value in accordance with a vehicle status.

3. The traction control device according to claim 2, wherein
the threshold value setting unit uses a parameter representing driving force and sets the predetermined threshold value based on a variation in the driving force represented by a variation in the parameter, and
the predetermined threshold value is set larger as the driving force decreases.

4. The traction control device according to claim 3, wherein
the threshold value setting unit uses a gear position as the parameter representing driving force to set the predetermined threshold value.

5. The traction control device according to any one of claim 2, wherein
the threshold value setting unit uses a parameter related to running resistance and sets the predetermined threshold value based on a variation in the parameter, and
the predetermined threshold value is set larger as the running resistance increases.

6. The traction control device according to claim 5, wherein
the threshold value setting unit uses at least one of a vehicle weight and a road gradient or a combination thereof as the parameter related to running resistance to set the predetermined threshold value.

7. A traction control device for a manual transmission vehicle, wherein
the traction control device according to claim 1 is applied to a vehicle with a manual transmission.

8. A traction control device comprising:
a traction control initiation determination unit for determining the initiation of traction control when a slip ratio of the driving wheel is equal to or greater than a predetermined slip ratio;
a threshold value setting unit for setting a predetermined threshold value used for determining an existence of an engine stalling tendency; and
an engine stalling tendency detection unit for detecting the existence of an engine stalling tendency that a value representing the engine speed is equal to or less than the predetermined threshold value set by the threshold value setting unit, wherein
the threshold value setting unit sets the predetermined threshold value in accordance with a vehicle status, and
if the traction control initiation determination unit detects the engine stalling tendency and traction control is initiated, then the traction control is subsequently terminated if the engine stalling tendency detection unit detects that the engine speed is equal to or less than the predetermined threshold value.

9. The traction control device according to claim 8, wherein
the threshold value setting unit uses a parameter representing driving force and sets the predetermined threshold value based on a variation in the driving force represented by a variation in the parameter, and
the predetermined threshold value is set larger as the driving force decreases.

10. The traction control device according to claim 9, wherein
the threshold value setting unit uses a gear position as the parameter representing driving force to set the predetermined threshold value.

11. The traction control device according to any one of claim 8, wherein
the threshold value setting unit uses a parameter related to running resistance and sets the predetermined threshold value based on a variation in the parameter, and
the predetermined threshold value is set larger as the running resistance increases.

12. The traction control device according to claim 11, wherein
the threshold value setting unit uses at least one of a vehicle weight and a road gradient or a combination thereof as the parameter related to running resistance to set the predetermined threshold value.

13. The traction control device according to any one of claim 8, further comprising:
an acceleration slip determination unit for determining whether an acceleration slip has fallen below a threshold value when the engine stalling tendency detection unit determines that the engine speed is not equal to or less than the predetermined threshold value, wherein
the traction control is terminated if the acceleration slip determination unit determines that the acceleration slip is less than the threshold value, and the traction control is continued if the acceleration slip determination unit determines that the acceleration slip is not less than the threshold value.

14. A traction control device for a manual transmission vehicle, wherein
the traction control device according to claim 8 is applied to a vehicle with a manual transmission.

15. A traction control device comprising:
a traction control unit for executing traction control to suppress acceleration slip of a driving wheel;
a traction control initiation determination unit for determining the initiation of traction control when a slip ratio of the driving wheel is equal to or greater than a predetermined slip ratio; and
an engine stalling tendency detection unit for detecting an existence of an engine stalling tendency that a value representing the engine speed is equal to or less than a predetermined threshold value; wherein
if the engine stalling tendency detection unit detects the engine stalling tendency, then initiation of traction control is prohibited regardless of whether the traction control initiation determination unit determines that the slip ratio is equal to or greater than the predetermined slip ratio, and
if the traction control initiation determination unit detects the engine stalling tendency and traction control is initiated, then the traction control is subsequently terminated if the engine stalling tendency detection unit detects that the engine speed is equal to or less than the predetermined threshold value.
